(19) United States
(12) Patent Application Publication
(10) Pub. No.: US 2008/0027761 A1
(43) Pub. Date: Jan. 31, 2008

(54) System and method for verifying driver's insurance coverage

(76) Inventor: Avraham Bracha, Plano, TX (US)

Correspondence Address: ANDREWS KURTH LLP;Intellectual Property Department, Suite 1100, 1350 I Street, N.W., Washington, DC, 20005, US

(21) Appl. No.: 11/517,270

(22) Filed: Sep. 8, 2006

Related U.S. Application Data
(60) Provisional application No. 60/832,953, filed on Jul. 25, 2006.

(51) Int. Cl. G06Q 40/00

(52) U.S. Cl. 705/4

(57) ABSTRACT

A system and method for insurance coverage verification. A computerized system for insurance coverage verification includes an insurance coverage verification server that receives and processes requests for insurance coverage verification, an insurance coverage verification database that stores insurance coverage information in a plurality of motorist records that are indexed by DLs and a network connection for receiving the insurance coverage verification requests and communicating responses to the insurance coverage verification. Each request for insurance coverage verification includes a driver's license number (“DL”) identifying a motorist for which insurance coverage verification is sought. The insurance coverage verification server verifies that the motorist has insurance coverage by matching the DL included in a request to an indexing DL in the database and retrieving the DL-indexed motorist record. The DL-indexed record is the motorist's only proof of insurance.

### CROSS REFERENCE TO RELATED APPLICATION(S)

This application claims priority from U.S. Provisional Application No. 60/832,953, filed Jul. 25, 2006 entitled “SYSTEM AND METHOD FOR VERIFYING DRIVER'S INSURANCE COVERAGE” the content of which is incorporated herein in its entirety to the extent that it is consistent with this invention and application.

### BACKGROUND OF THE INVENTION

Most states require motor vehicle drivers to maintain insurance coverage. The intention of a state statute is to enforce financial responsibility on an individual that is legally licensed to operate a motor vehicle. As a result, every active licensed driver must purchase insurance coverage. The driver whom obtains insurance from the insurance company receives a proof of insurance card (Card).

The state requires this Card during several separate procedures: 1) traffic citation, 2) annual vehicle registration, 3) vehicle annual safety inspection, and 4) it is an essential part of post auto accident procedures. Throughout the procedures the Card is visually scrutinized by the respective personnel (i.e. police officer, tax assessor, safety inspection personnel, etc.)

The Card is intended to be a legal document that confirms the driver's acquisition of insurance coverage. Yet, in reality, its authenticity is often disputed. Due to monetary constrain or carelessness, a driver often resorts to a range of methods to avoid the financial burden of insurance coverage. For example, some motorists terminate the insurance coverage after receiving the Card. Hence, the Card is only a testimony that insurance coverage was in force at the time it was issued. Moreover, with the proper computer software, a counterfeit Card can be produced, and presented as proof of insurance.

The ability to manipulate or forge the insurance Card provides a path for deceptive behavior. The Card allows the motorist to control the insurance information flow between insurance companies and the state, as well as other entities. However, the most fundamental disadvantage resides within the matching process between the state vehicle and owner records and insurance coverage record.

In addition to the aforementioned driver-authorities encounters some states resort to a random matching procedure between the state vehicle ownership records and the vehicle insurance record. The core process in this formula utilizes the Vehicle Identification Number (VIN) to identify the vehicle owner that does have or does not have insurance.

The matching process between the state and the insurance company tries to assent VIN in the Department of Motor Vehicle (DMV) ownership database with an identical VIN in the insurance company. The two VINs must accurately correspond to indicate on insurance coverage existence. However, by utilizing the VIN in the confirmation scheme the process experiences drawbacks. Frequent inconsistencies between the two VINs cause significant misidentifications of insured as uninsured drivers and/or vice versa. Another important disadvantage is the inability to authenticate non-owners insurance coverage at any time.

In conclusion, the incumbent insurance verification process endures two major weaknesses: 1) The Card presents an opportunity for the driver to control the information flow between the insurance companies and the assorted authorities, and 2) the process based on VIN correspondence impedes integrity and efficiency of the present program. To significantly reduce the inadequacies of the current system, the driver's role must be defused, and motorist based insurance authentication must be initiated. There is a potential process that would significantly reduce forgery and provide the police officers with an improved verification process. An overview of this potential solution is presented herein.

### SUMMARY

An advantage of the embodiments described herein is that they overcome the disadvantages of the prior art. These advantages and others are achieved by computerized system for insurance coverage verification includes an insurance coverage verification server that receives and processes requests for insurance coverage verification, an insurance coverage verification database that stores insurance coverage information in a plurality of motorist records that are indexed by DLs, and a network connection for receiving the insurance coverage verification requests and communicating responses to the insurance coverage verification. Each request for insurance coverage verification includes a driver's license number (“DL”) identifying a motorist for which insurance coverage verification is sought. The insurance coverage verification server verifies that the motorist has insurance coverage by matching the DL included in a request to an indexing DL in the database and retrieving the DL-indexed motorist record. The DL-indexed record is the motorist's only proof of insurance.

These advantages and others are also achieved by a computer-assisted method for insurance coverage verification. The method includes receiving a driver's license registration. The driver's license registration indicates the issuance or renewal of a driver's license for a motorist and includes a driver's license number (DL). The method creates a motorist record for the motorist in an insurance verification database. The motorist record is indexed by the DL. The method receives an insurance coverage registration in which the insurance coverage registration indicates issuance of insurance coverage for the motorist and includes the motorist's DL and insurance coverage information. The method looks up the motorist record using the motorist's DL and stores the insurance coverage information with the motorist record located using the motorist's DL. The motorist record and the insurance coverage information stored therewith is the motorist's sole proof of insurance. A computer-readable medium comprising instructions for performing this method also achieves these advantages and others.

These advantages and others are also achieved by a computer-assisted method of verifying insurance coverage. The method receives a driver's license number (DL) of a motorist, connects to an insurance coverage verification system, requests insurance coverage verification using only the DL, and receives insurance coverage verification if the DL matches a DL in the insurance coverage verification system of a motorist with insurance coverage. The DL is provided to the insurance coverage verification system to confirm insurance coverage. A computer-readable medium comprising instructions for performing this method also achieves these advantages and others.

### DESCRIPTION OF THE DRAWINGS

The detailed description will refer to the following drawings, wherein like numerals refer to like elements, and wherein:

FIG. 1 is a block diagram illustrating an embodiment of a system for verifying insurance coverage.

FIG. 2 is a flowchart illustrating an embodiment of a method for verifying insurance coverage.

FIG. 3 is a block diagram illustrating an embodiment of a system and method for verifying insurance coverage.

FIG. 4 is a block diagram illustrating an embodiment of a system and method for verifying insurance coverage during driver's license issuance or renewal.

FIG. 5 is a block diagram illustrating an embodiment of a system and method for verifying insurance coverage by law enforcement personnel (e.g., police officer, state trooper, etc.) while on duty.

FIG. 6 is a block diagram illustrating an embodiment of a system and method for verifying insurance coverage of out of state drivers by law enforcement personnel.

FIG. 7 is a block diagram illustrating an embodiment of a system and method for verifying insurance coverage by drivers involved in an accident.

FIG. 8 is a block diagram illustrating an embodiment of a system and method for verifying insurance coverage providing automated insurance verification and enabling a vehicle owner to renew a motor vehicle registration via the Internet.

FIG. 9 is a block diagram illustrating an embodiment of a system and method for verifying insurance coverage providing automated insurance verification when a County Tax Assessor (CTA) carries out a motor vehicle registration procedure.

FIG. 10 is a block diagram illustrating an embodiment of a system and method for verifying insurance coverage providing automated insurance verification in an Internet based vehicle registration procedure administered by a car dealership.

FIG. 11 is a block diagram illustrating an embodiment of a system and method for verifying insurance coverage providing automated insurance verification during vehicle inspection at a Safety Inspection Station.

FIG. 12 is a block diagram illustrating an embodiment of a system and method for verifying insurance coverage providing identification (ID) authentication process.

FIG. 13 is a block diagram illustrating an embodiment of a system for verifying insurance coverage, including a network of various supporting databases.

FIG. 14 is a block diagram illustrating exemplary hardware components of a system for verifying insurance coverage.

### DETAILED DESCRIPTION OF THE DRAWINGS

Described herein are methods and systems for verifying insurance coverage. Embodiments of the method and system may be used for various purposes. For example, embodiments may provide various law enforcement organizations with a twenty-four, seven comprehensive processes that will promptly confirm driver's insurance coverage. Likewise, embodiments may permit entities that offer state required services to verify the existence of insurance. Further, embodiments may provide federal and civil entities a mechanism that handles identity authentication.

Resolving the Uninsured Motorists (UIM) problem requires collaboration between state insurance companies and the public. A successful resolution mandates a change in the insurance verification model. Embodiments described herein achieve this change through a comprehensive process that provides a real-time verification of a driver's insurance legitimacy via the Internet that can be made available in a police patrol squad car. This web-based Insurance Verification process employs existing data to identify UIM. With minimal state and insurance company investment or ongoing expenditure, the embodiments described herein significantly reduce the UIM problem.

Embodiments described herein use the Driver's License Number (DL) as a central component. The driver's license is used across many daily venues. The driver's license is an official document produced by the state. It includes a picture and information such as, the motorist information, and the DL. The DL, in particular, is a number accepted in many industries as an authenticated identification method. Many industries use the DL as part of a person's identity records, and others use the license as a picture ID. A primary example is the use of the driver's license as part of the security check for air travel. Other industries that use the DL include insurance companies, state departments, and many others businesses. By using the DL as the core in the new insurance verification model provided by embodiments described herein, the driver's sole responsibility, regarding insurance coverage, will be to acquire or cancel the insurance coverage and maintain a valid driver's license.

Embodiments include a Motorist Insurance Verification System (MIVS). The MIVS primarily maintains motorist insurance coverage data. Embodiments of the MIVS require departments such as, e.g., the Department of Motor Vehicle (DMV), Department of Public Safety (DPS), and Department of Insurance (DI), to share motorist and vehicle data. The insurance companies provide the insurance information. In the embodiments described herein, the proof of insurance is the driver's license itself. Through implementation of the embodiments described herein, the insurance Card will be eliminated and all verifications will occur in the MIVS.

The FIGURES herein illustrate how the driver's license is used in situations that require proof of insurance. As a user friendly system, the MIVS streamlines the information to accommodate the unique requirements of each user. In the embodiments described herein, a DL is keyed in a computer procedure and a search process is launched to find this DL with a valid insurance policy. If the search results in a positive match and the insurance is current, the driver is insured. If there is no corresponding insurance record, the driver is an UIM.

The utilization of the DL in the new verification method and system enhances reliability, accuracy, and authorities' enforcement of the insurance statues. Importantly, the method and system described herein alleviates the current UIM problem. Moreover, the method and system validate insurance for both motorists whom own a vehicle and those who do not. Using current technology, the method and system respond promptly to insurance confirmation inquiries consistently and precisely, and support automation in other processes that require proof of insurance.

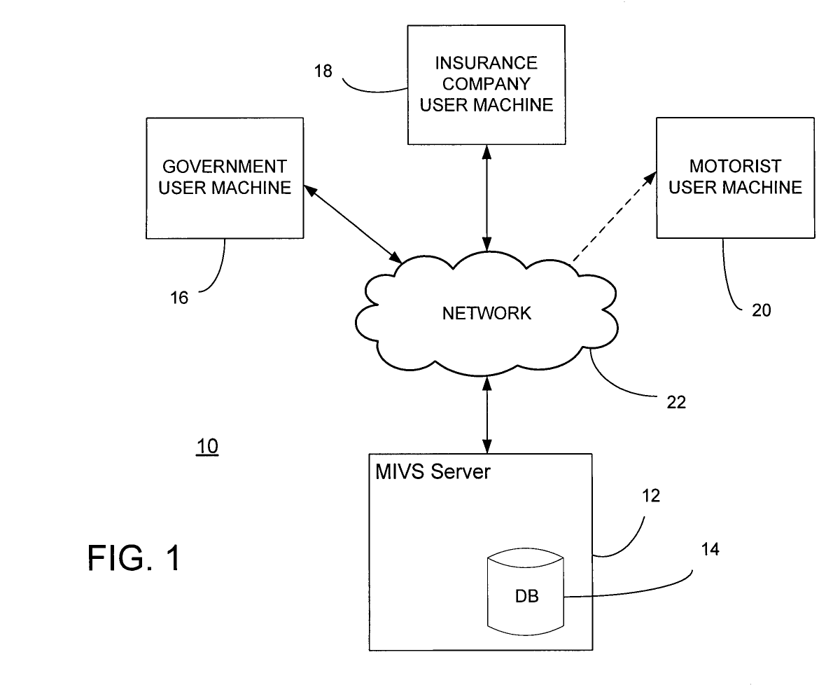

With reference now to FIG. 1, shown is an embodiment of system 10 for verifying insurance coverage. System 10, referred to herein as Motorist Insurance Verification System (MIVS), is not limited to any particular hardware components or structure. The embodiment shown in FIG. 1 is for illustrative purposes. In the embodiment shown, MIVS 10 includes MIVS server 12 and MIVS database 14. MIVS 10 may also include software and/or other computer instructions for performing the methods and actions described herein. This software may be embodied as a MIVS application that performs the methods described herein, or steps thereof. Numerous variations will be apparent from the description provided herein.

MIVS 10 may be implemented, for example, on a national basis (e.g., for all of the USA, all of Canada or all of Mexico, etc.), on a multi-national basis (e.g., all of the USA and Canada), on a jurisdiction-by-jurisdiction basis (e.g., for individual states on a state-by-state basis), or otherwise (e.g., groups of states). Each MIVS 10 implementation or instance may be controlled, e.g., by government entity (e.g., state agencies, such as DMV, DPS or DI), by insurance companies or by third-parties (e.g., companies that exist to run and manage MIVS 10 instance for a state).

MIVS 10 includes MIVS server 12, MIVS database 14, a variety of user machines (e.g., user machines 16-20) and network 22. MIVS server 12 may maintain motorist insurance coverage data, including the DL and insurance coverage information associated with the DL. Additional information may be included with motorist insurance coverage data, including name, address, age, height, weight, telephone number, social security number, etc. Virtually any information that may be obtained about a motorist by a government agency (e.g., DMV, DPS, DI, etc.) or an insurance company may be stored on MIVS server 12. Motorist insurance coverage data may be maintained in a database, such as MIVS database 14. The data may be partitioned, grouped or otherwise restricted by access privilege level. In other words, certain users may be able to access all of the motorist data, while others, such as motorists themselves, may only be permitted to access a limited amount of data, such as simply an indication that a driver is insured.

With continuing reference now to FIG. 1, a user of MIVS 10 may access MIVS 10 and the motorist insurance coverage data using a user machine and connecting to MIVS server 12 and/or MIVS database 14 via network 22 (or directly using MIVS server 12). Network 22 may be the Internet or a variety of other networks, such as a LAN. User machines include government user machine 16 for use by government agency employees, such as DMV employees, law enforcement employees, etc. User machines may include desktop computers, servers, laptop and notebook computers, telephones, cell phones, any wireless device that can access the Internet, and virtually any type of computer. Government user machines 16 may be used by government users in order to register motorists with MIVS 10, e.g., uploading DLs into MIVS 10, and to store additional motorist information in MIVS 10. Such information may be uploaded by government users manually or through automated processes. Alternatively, this information may be automatically uploaded without user intervention by servers or other computers connecting to MIVS 10 through network 22. Government users may also use government user machines 16 to obtain (download) information from MIVS 10. For example, police officers may download insurance coverage information from MIVS 10.

Insurance company user machines 18 are used by insurance company users to register insurance coverage with MIVS 10. Insurance coverage information may be uploaded into MIVS 10 for storage on MIVS server 12 and/or MIVS database 14 via network 22. Additional information may be uploaded. Such information may be uploaded by insurance users manually or through automated processes. Alternatively, this information may be automatically uploaded without user intervention by servers or other computers connecting to MIVS 10 through network 22. Insurance users may also use insurance user machines 18 to obtain (download) information from MIVS 10.

With continuing reference to FIG. 1, motorist user machine 20 may be used by motorists to obtain information from MIVS 10. Such information that may be obtained by motorists may be limited to motorist insurance coverage information regarding the motorist his/herself or simply an indication that another motorist is insured and providing the insurance company name and information. For example, a motorist may simply enter in a DL and receive a response indicating that the driver with the DL is insured and providing the insurance company name and information. A motorist may also obtain such information by telephoning MIVS 10 and connecting to it through an automated telephone access system provided by software on MIVS server 12 or through a live MIVS operator. Accordingly, an MIVS operator may access MIVS server 12 and/or MIVS database 14 through a MIVS user machine (not shown). Other MIVS user machines may be included for accessing MIVS 10, such as car dealership or car rental company user machines (not shown). Indeed, virtually any computer with network 22 access (e.g., Internet access) and appropriate software for connecting to MIVS server 12 and/or MIVS database 14 may be used to access MIVS 10.

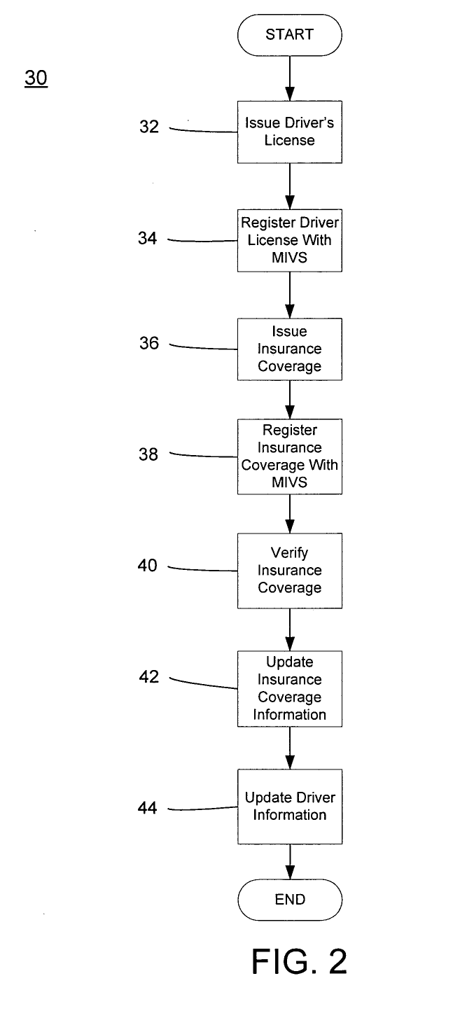

With reference now to FIG. 2, shown is an embodiment of method 30 for verifying insurance coverage. A government agency, contracting company or other entity issues a driver's license to a motorist, block 32. For example, a state DMV or DPS may issue the driver's license. In some states, companies are contracted by the state government to act as and provide the services of the DMV or DPS, and those companies would issue the driver's license. The driver's license is registered with MIVS 10, block 34. The registration of the driver's license may create or cause the creation of a motorist record indexed by DL in MIVS 10 (e.g., in MIVS database 14). The registration of the driver's license, and hence the DL, may be performed, e.g., by the government agency, contracting company or other entity connecting with MIVS server 12 and/or MIVS database 14 and uploading the DL and other information. The driver's license issuing entity may have, for example, a computer system configured to automatically register the driver's license with MIVS 10. Consequently, whenever a new driver's license is issued, the computer system may, e.g., automatically connect to the MIVS server 12 and/or MIVS database 14 and upload the DL and other information. When MIVS 10 is initiated and set-up for a new jurisdiction (e.g., a state), existing driver's licenses may be registered with MIVS 10 per the above.

An insurance company issues insurance coverage to the motorist, block 36. A motorist obtains the insurance coverage through ordinary means (e.g., directly contacting the insurance company, through an insurance agent, via telephone, via the Internet, via mail, etc.). When the insurance coverage is issued, the motorist provides certain information to the insurance company, including the DL, name, address, other contact information, vehicle information (e.g., VIN numbers and other identifying information for insured vehicles), etc. Insurance coverage information is often obtained for more than one motorist at a time. Consequently, the motorist will typically provide the same information, including the DL, for the other driver. In embodiments described herein, the insurance company does not issue Cards or other physical proof of insurance. Rather, the motorist's proof of insurance will be maintained by MIVS 10. Accordingly, the insurance coverage is registered with MIVS 10, block 38. This may be done, e.g., by the insurance company connecting with MIVS server 12 and/or MIVS database 14, looking up the motorist's record with the DL, and uploading insurance coverage information with the associated DL and storing the uploaded insurance coverage information with the associated DL and related motorist data in the motorist's record. Registering the insurance coverage information may include connecting to MIVS server 12 and/or MIVS database 14, locating the motorist's record by searching for the insured motorist's DL, and saving the insurance coverage information in MIVS server 12 and/or MIVS database 14. Alternatively, registering the insurance coverage with MIVS 10 may cause the initial creation of the motorist's record indexed by DL in MIVS 10 (e.g., in MIVS database 14). The insurance company or other entity may have, for example, a computer system configured to automatically register the insurance coverage information (e.g., by performing the above steps) when new insurance coverage is issued. When MIVS 10 is initiated for a new jurisdiction (e.g., a state), existing insurance coverage information may be registered with MIVS 10 per the above.

With continued reference to FIG. 2, use of MIVS 10 is shown. A typical use of MIVS 10 is to verify insurance coverage information, block 40. For example, a law enforcement officer, DMV, safety inspection station, motorist involved in accident, etc., may connect with MIVS 10 to verify that a motorist has insurance coverage. MIVS 10 may also be used to verify that a motorist is insured for the vehicle the motorist is driving. The insurance coverage information verifying 40 may include a user connecting with MIVS 10, searching for the motorist's record by entering and searching for a DL match, and retrieving the motorists' insurance coverage information (and/or other information stored with motorist's record as described above). A user verifying insurance coverage information may connect to MIVS server 12 and/or MIVS database 14 using a user machine (e.g., a police computer in a patrol car). The user machine may be configured with software that automatically connects to MIVS server 12 and/or MIVS database 14 and verifies insurance coverage information per the above whenever a DL is entered by the user. Alternatively, a user may contact MIVS 10 via telephone, either speaking to a human operator that accesses MIVS server 12 and/or MIVS database 14 and conducts verification or by interacting with an automated telephonic access system.

MIVS 10 is preferably updated anytime insurance coverage information is changed. For example, a motorist changes his/her insurance coverage or insurance coverage is cancelled, for example, and insurance coverage information in MIVS 10 is updated, block 42. This may include insurance company connecting with MIVS 12 and/or MIVS database 14, looking up insurance coverage information using DL and updating the information (e.g., by over-writing existing insurance coverage or associated information with new information). Insurance company user machine or computer system may be configured to automatically connect to MIVS 10 anytime insurance coverage or associated information is changed and to update the motorist's record. Other methods of updating the motorist's record consistent with the above may be used.

In embodiments, the registration of the driver's license in MIVS 10 may be skipped and the DL only registered in MIVS 10 when insurance coverage is provided. In other words, MIVS 10 may be configured so that the only DL that are stored in MIVS server 12 and/or MIVS database 14 are DLs of motorists that obtain insurance coverage. Subsequently, verification of insurance coverage may be simplified to a simple search for a DL match; if there is not DL match in MIVS server 12 and/or MIVS database 14, then the motorist does not have coverage.

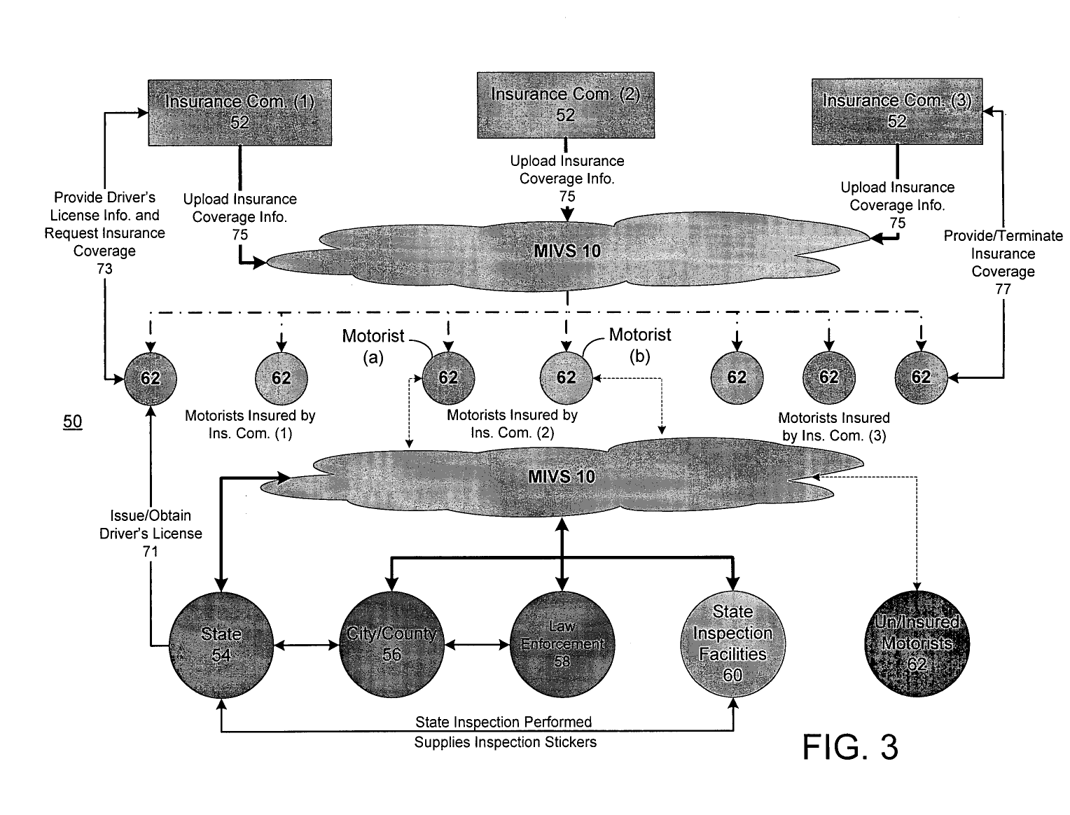

With reference now to FIG. 3, shown is an embodiment of a method and system 50 for insurance coverage verification utilizing MIVS 10. FIG. 3 illustrates the flow of motorist insurance coverage information between insurance companies 52 and entities that need access to up-to-date insurance coverage information. Such entities include state agencies and other state entities 54, city/county agencies and other city/county tax assessor or other entities 56, law enforcement entities 58, state inspection facilities 60, and insured and uninsured motorists/drivers 62. In the embodiment shown, insurance coverage information flows through the Internet, from insurance companies 52 to diverse clientele. FIG. 3 emphasizes the driver's task being restricted to sheer acquisition or termination of the insurance coverage. The state 54 (e.g., DMV) and insurance companies 52 convey the appropriate information of the motorist to MIVS 10 where the process of matching the DL to insurance coverage information is accomplished.

Part of the uniqueness of the embodiments described herein is the usage of the undisputable DL as a unified code. By using the DL, the method and system 50 delineate numerous potential possibilities to frequently confirm insurance existence with minimum discrepancies. The driver's 62 responsibilities are restricted to two tasks: 1) getting driver's license from the state 54 and 2) acquiring the necessary insurance coverage from an insurance company 52. In return, the insurance company 52 provides coverage to the driver 62, and transmits the insurance information to MIVS 10. The driver uses the driver's license and the DL as the new proof of insurance, instead of the printed Card.

With continued reference to FIG. 3, to be eligible for motorist insurance coverage the motorist 62 must obtain a driver's license from the state 54 (the state 54 issues the driver's license to the motorist 62), block 71. Thereafter, the motorist 62 must provide the driver's license information to and request insurance coverage from an insurance company 52, block 73. The insurance company 52 uploads or otherwise provides the motorist insurance coverage information to MIVS 10, block 75, storing the insurance coverage information with the DL of the motorist 62 in MIVS 10 (e.g., MIVS server 12 and/or MIVS database 14). This may include the creation of a record, indexed by DL, for the motorist in MIVS server 12 and/or MIVS database 14 and the storage of the insurance coverage information with the motorist's record. The insurance company 52 informs the motorist 62 of the insurance coverage contract (provides insurance coverage), block 77 (insurance company 52 may subsequently terminate insurance coverage, either at motorist's request or for other reasons). Subsequently, the motorist 62 may contact (e.g., call up the insurance company 52) to terminate or modify insurance coverage. If the insurance coverage is terminated or modified, the insurance company 52 provides the updated insurance coverage information to MIVS 10, updating the motorist's insurance record in MIVS 10. A major purpose of the system is to identify UIMs. By listing all motorists, insured and uninsured, MIVS 10 will be able to extract UIMs for law enforcement. For example, if there is a vehicle that multiple motorists can operate, but insurance coverage for one of the motorists was terminated, MIVS 10 will show this UIM's record as a hot point so the police can click on it and see information regarding the UIM (e.g., his picture, a description, etc.). Using the retrieved UIM's information, a law enforcement officer can determine by visual inspection and comparison of a motorist driving a vehicle whether the motorist is a UIM. If the motorist appears to match the retrieved UIM information, the law enforcement officer may stop the vehicle simply on suspicion of operating without insurance. There are many drivers that dodge the insurance coverage requirement, without being ever caught, simply because they do not make any moving violations. In this manner, MIVS 10 enables law enforcement to catch UIMs that otherwise would not be caught. In an alternative embodiment, if the insurance coverage is terminated, the insurance company 52 may delete the motorist's entire record from MIVS 10. Subsequently, when the motorist is stopped for a moving violation, the lack of a record will indicate to the law enforcement officer that the motorist is a UIM. The disadvantage of deleting the motorist's record is that MIVS 10 will not enable law enforcement to proactively determine and stop UIMs, as described above.

In the embodiment shown in FIG. 3, the insurance companies 52 provide the DL to MIVS 10 when uploading the insurance coverage information. Consequently, in such an embodiment, only DLs for insured motorists 62 are stored in MIVS 10, as discussed above. Alternatively, DLs for all motorists are stored in MIVS 10 and only those motorists with insurance coverage will have insurance coverage information stored with their DL. In such an embodiment, the driver license issuing entity (e.g., DPS or DMV) may initially provide the DL to MIVS 10. Providing the DL to MIVS 10 may create a record for the motorist, indexed by DL, in MIVS server 12 and/or MIVS database 14. Subsequently, when an insurance company 52 issues insurance coverage, the existing motorist's record may be located in MIVS 10 using the motorist's DL provided by the motorist 62, and the insurance coverage information uploaded and stored with the existing motorist's record.

Uninsured and insured motorists 62 typically have limited access to MIVS 10 and the information maintained therein, as indicated by the dashed lines in FIG. 3. One example is when a motorist 62, e.g., motorist (a), is involved in an accident with another motorist 62, e.g., motorist (b). Motorist (a) may contact MIVS 10, as described above, to obtain insurance coverage information about the other motorist, motorist (b). Motorist (a) obtain motorist (b)'s DL and provides the DL to MIVS 10. If motorist (b) has insurance coverage, such insurance coverage information is returned to motorist (a). Likewise, motorists 62 may access MIVS 10 to obtain their own insurance coverage information. For example, motorist (b) may contact MIVS 10 to determine when his/her insurance coverage expires.

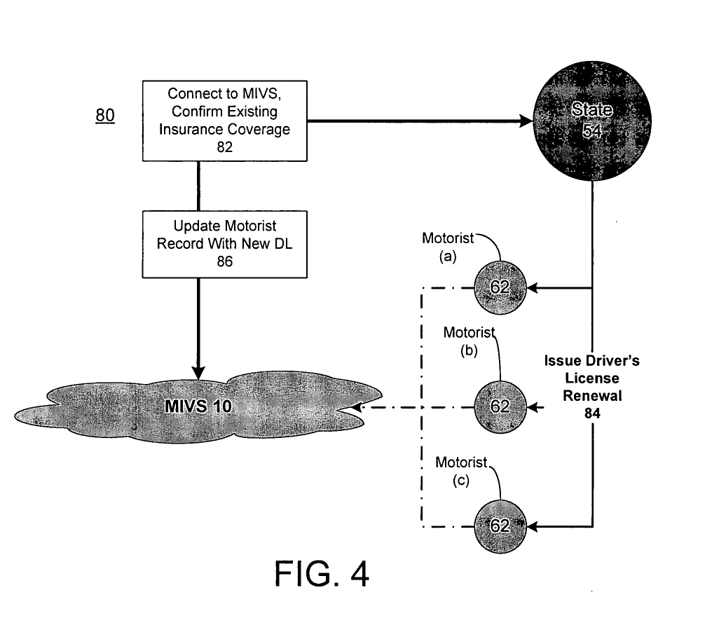

With reference now to FIG. 4, shown is an illustration of how embodiments of the method and system for insurance verification are incorporated in the process of issuing or renewals of driver's license. Specifically, system and method 80 of verifying insurance coverage during renewal of a driver's license is shown. A motorist/driver 62 (e.g., motorist (a), (b) or (c)) requests renewal of his/her driver's license from appropriate state agency or entity 54 (not shown). The request may be done in person, e.g., at a DMV, over the telephone, or on-line (e.g., using motorist user machine 20). The state 54 connects to MIVS 10 to confirm insurance coverage for the requesting motorist 62, block 82. The state 54 may connect via government user machine 16, automated systems, or in any of the manners described herein or known to one of ordinary skill in the art, to MIVS server 12 and/or MIVS database 14 to obtain the necessary insurance coverage information. Once state 54 receives the necessary insurance coverage verification, state 54 issues driver's license renewal, block 84. If state 54 issues a new DL as part of the renewal, motorist record in MIVS 10 is updated, block 86 An indication of driver's license renewal may be communicated over Internet to the motorist, e.g., via motorist user machine 20. The dashed lines between motorist 62 and MIVS represent two points: (1) motorist 62 has an ability to verify his/her own insurance coverage, as described herein and (2) motorist 62 has an indirect control over the information stored in MIVS 10.

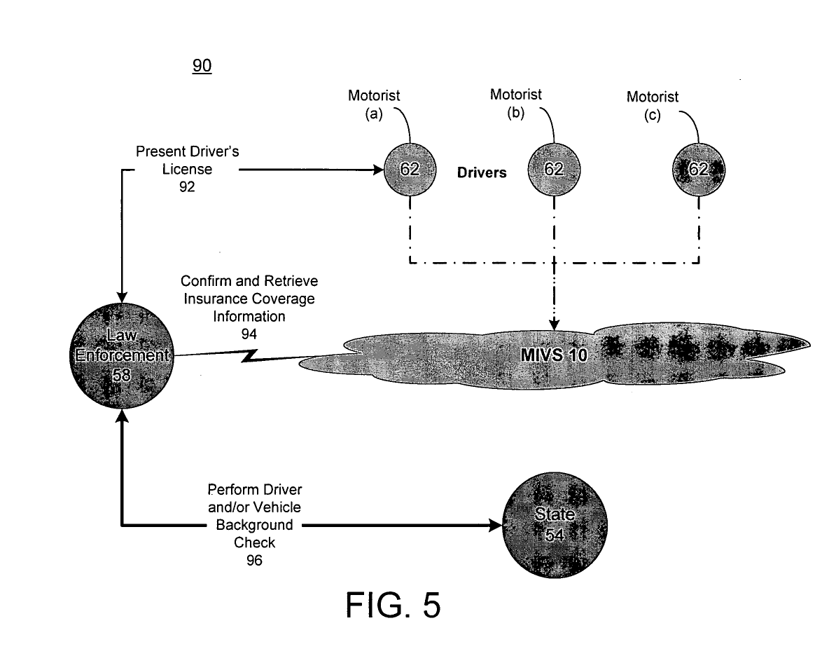

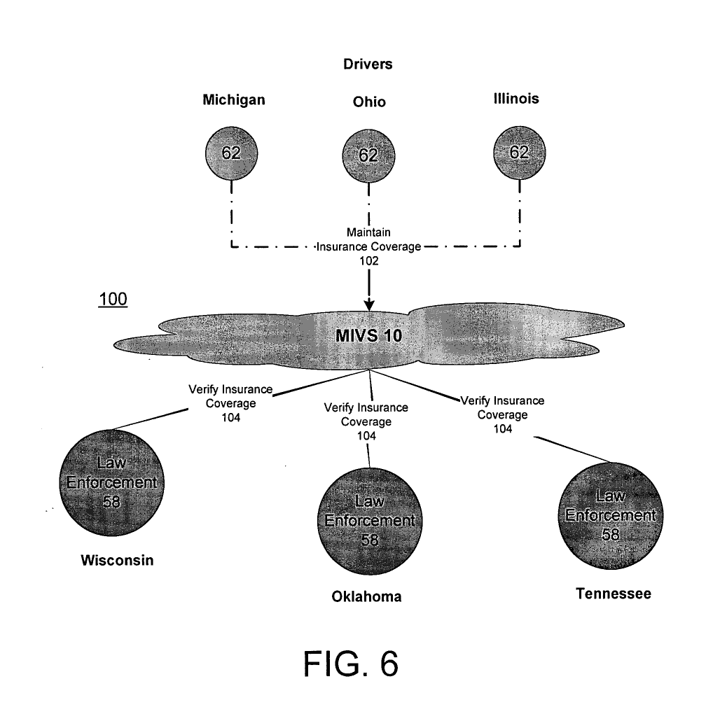

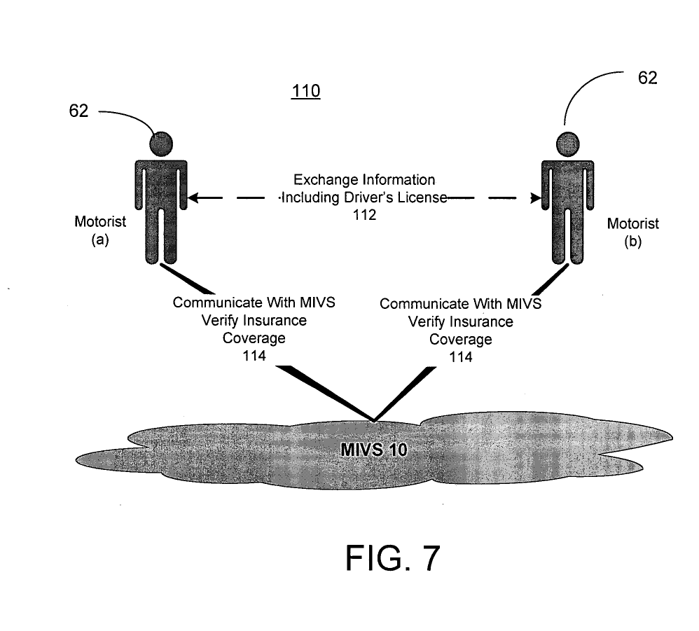

The next three figures depict the integration of MIVS 10 during a traffic citation (FIG. 5), the ability of law enforcement from different states to retrieve the information stored in MIVS 10 (FIG. 6), and in the event of an accident, the confirmation by involved motorists of each other's insurance coverage by accessing MIVS 10 (FIG. 7).

With reference now to FIG. 5, shown is an illustration of a law enforcement officer's ability to instantaneously verify insurance by accessing MIVS 10 from his/her patrol car. Specifically, system and method 90 for verifying insurance coverage by a law enforcement officer is shown. A driver/motorist 62 is stopped by an officer (not shown), e.g., for an observed violation. The motorist 62 presents the driver's license to the officer, block 92. Using the DL from the driver's license, the officer confirms and retrieves the motorist's insurance coverage info from MIVS 10, block 94. This may include the officer connecting to MIVS server 12 and/or MIVS database 14 using government user machine 16. Such a government user machine 16 may be a police computer typically installed in the squad car. The police computer may automatically or at the officer's prompting connect wirelessly (e.g., over the Internet) with MIVS 10. Alternatively, the police computer may connect with a police station computer which may then connect with MIVS 10. The insurance coverage information, including an indication of no insurance coverage if applicable, may be returned to the police computer in the officer's squad car. The police officer may perform driver's and vehicle's background check with a state agency 54, e.g., a State Information System, block 96. Alternatively, the background information may be stored in MIVS 10. The officer may present a citation to the motorist (not shown). If the insurance coverage information indicated not insurance coverage, the officer may issue a citation for lack of insurance coverage and/or immediately arrest the uninsured motorist, consequently directly attacking the UIM problem.

With reference now to FIG. 6, shown is an embodiment of MIVS 10 that permits law enforcement units 58 from multiple states (or other multiple jurisdictions) verify insurance coverage of out of state (or out-of-country) drivers 62. As shown in a method and system 100 for insurance coverage verification, motorists/drivers 62 from a variety of states (e.g., Michigan, Ohio and Illinois) maintain insurance coverage, block 102. By maintaining insurance coverage in states that participate in MIVS 10, the motorists' insurance coverage information is stored in MIVS 10 (e.g., in MIVS server 12 and/or MIVS database 14) with the motorists' DLs. Law enforcement units 58 may verify insurance coverage of out-of-state drivers as described above, e.g., with reference to FIG. 6, block 104. MIVS 10 may be implemented to permit out-of-jurisdiction insurance coverage verification in any geographical region. However, in certain embodiments, there may be stipulations to this paradigm: information transparency and accessibility is available only to program participating states. In other words, in some embodiments or implementations, only law enforcement officers from states participating in MIVS 10 may access another state's motorist insurance coverage information from MIVS 10.

With reference now to FIG. 7, shown is a diagram illustrating a system and method 110 of verifying insurance coverage information between motorists involved in an accident. In this manner, MIVS 10 permits parties involved in car accident to exchange information and access MIVS 10 to verify each other's insurance coverage. Often drivers are involved in accidents and presented with bogus proof of insurance. System and method 110 of verifying insurance coverage information helps to prevent this from happening. As shown, motorists 62 exchange information, block 112. The information exchanged includes each motorist's driver's license. Each motorist communicates with MIVS 10 and uses the DL to verify the existence of insurance coverage, block 114. For example, a motorist may use a motorist user machine 20 to connect with MIVS 10. Such a motorist user machine 20 may be a PDA, mobile phone, BlackBerry™, or other personal digital device with Internet access, a notebook or laptop with wireless connectivity, etc. Alternatively, a motorist may telephone MIVS 10 and speak to a human operator that accesses MIVS 10 or interact with an automated telephonic access system to directly access insurance coverage information from MIVS 10.

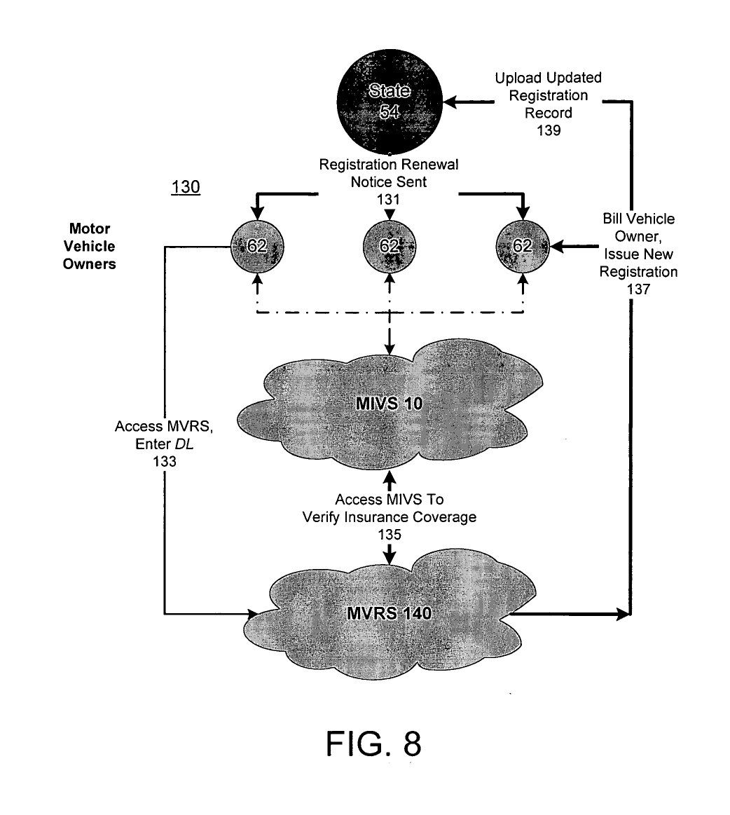

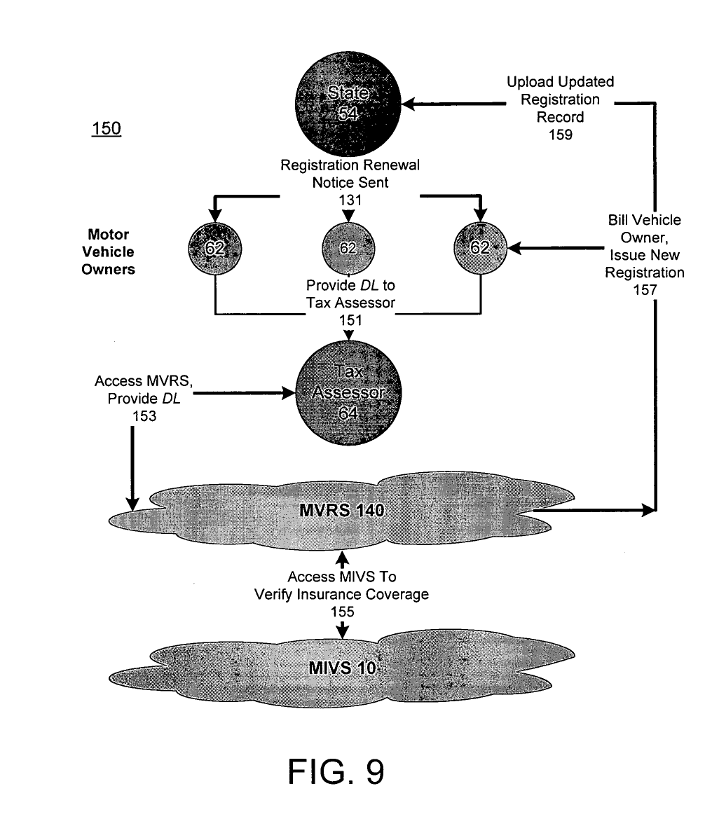

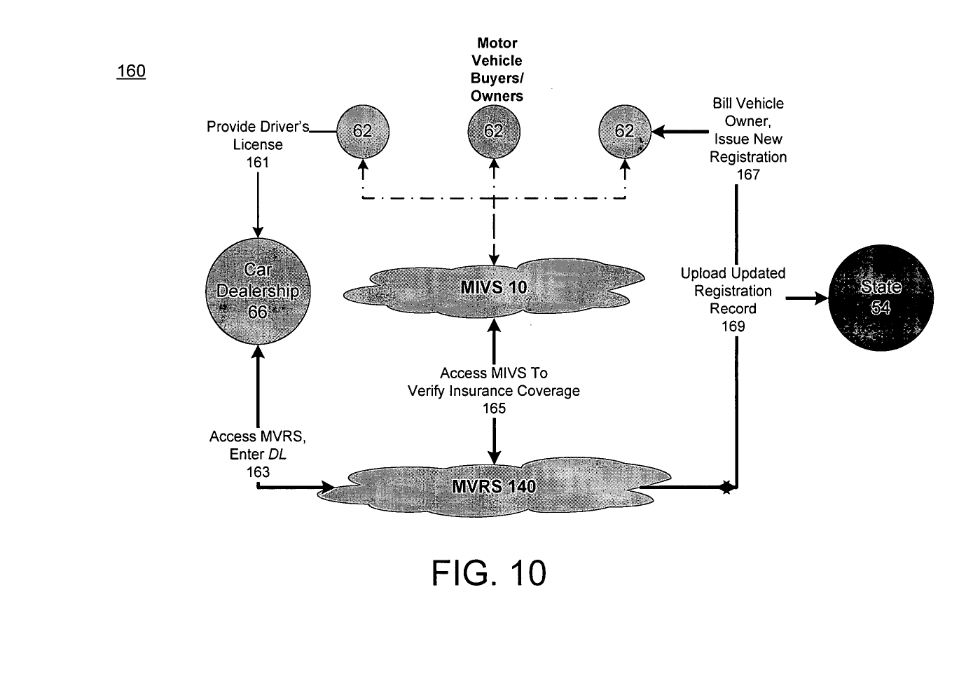

The next three figures demonstrate the incorporation of MIVS 10 in the motor vehicle registration procedure. In addition to MIVS 10, a new system is introduced, the Motor Vehicle Registration System (MVRS). The synthesis of the MVRS with MIVS 10 automates the motor vehicle registration procedure in diverse situations. The grouping of the two novel systems, MVRS and MIVS, allows an Internet-based motor vehicle registration by owner (FIG. 8), by a Tax Assessor (FIG. 9), and a car dealership (FIG. 10), in which the insurance confirmation process is totally handled by the MVRS.

With reference to FIG. 8, shown is a flow diagram exhibiting a system and method 130 for computer-based vehicle registration (e.g., via the Internet). As shown, system and method 130 for vehicle registration includes MIVS 10 and MVRS 140. Like MIVS 10, MVRS 140 may include a server (e.g., MVRS server (not shown)) and a database (e.g., MVRS database (not shown)) and may be accessed via a network, such as the Internet. In an embodiment, MIVS 10 and MVRS 140 may be hosted by the same server or servers. User machines, such as the user machines described above, may be used to access MVRS 140. Alternatively, MVRS 140 may include MVRS user machines for accessing MVRS 140. Stored within MVRS 140 (e.g., in MVRS server and/or MVRS database) is motor vehicle registration information. MVRS 140 also includes software and/or other computer instructions for performing the methods and actions described herein.

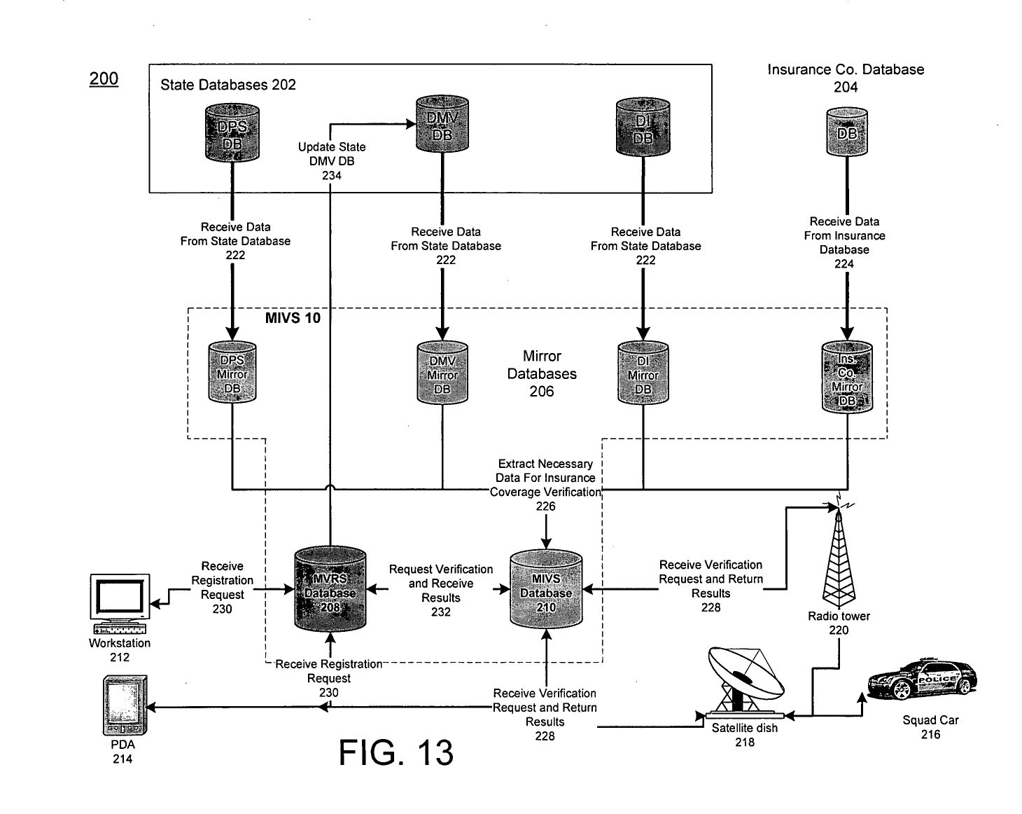

The integration of the MVRS 140 with MIVS 10 enables a vehicle owner to renew vehicle registration through a network connection to MVRS 140 (e.g., over the Internet). In system and method 130 for vehicle registration illustrated in FIG. 8, the insurance coverage verification process is automatically handled by MVRS 140. MVRS 140 accesses MIVS 10, e.g., via the Internet, a LAN or other network, or a direction connection, and inquires about the vehicle's owner insurance status. State 54 sends an annual motor vehicle renewal registration notice to the vehicle owner, block 131. The notice may include an access code. The motor vehicle owner (motorist 62) accesses MVRS 140 (e.g., via a network (e.g., Internet) connection, enters his/her access code, activates a web-based registration application, and enters his/her DL, block 133. The usage of the access code, as opposed to simply a VIN or other identifying number, is to restrict access to the MVRS 140 only to motorists that need to renew their vehicle registration. The entered DL is used to verify vehicle ownership by the vehicle owner/motorist (e.g., by accessing DMV mirror DB (see FIG. 13)) and verifying insurance coverage for the vehicle for the motorist (vehicle owner 62). Vehicle owner 62 may connect to MVRS using motorist user machine 20 or other device. Vehicle owner 62 may use a computer system configured to automatically connect to MVRS 140 and provide DL to MVRS 140. Entering the access code may cause MVRS 140 to initiate a web-based vehicle registration process. MVRS 140 accesses MIVS 10 for insurance coverage verification, block 135. For example, upon receiving DL, MVRS 140 may automatically connect to MIVS server 12 and/or MIVS database 14, pass the DL to look-up motorist 62 MIVS record, and retrieve/receive insurance coverage information from MIVS server 12 and/or MIVS database 14. Once insurance coverage information is confirmed for the vehicle owner 62 and the vehicle, the vehicle registration may be renewed. MVRS 140 may bill vehicle owner 62 for the renewal and issue a new registration sticker to vehicle owner 62, block 137. For example, MVRS 140 may include instructions for instructing label printing devices to print the registration sticker and mail it to vehicle owner 62. Alternatively, MVRS 140 may electronically transmit (e.g., e-mail) an electronic version of the registration sticker to vehicle owner 62 so that vehicle owner 62 may print the registration sticker him/herself. MVRS 140 may upload an updated registration record for vehicle owner 62 to the state vehicle registration record system, block 139. Alternatively, MVRS 140 may maintain all state vehicle registration records and may simple save the updated vehicle registration record (e.g., on MVRS server and/or MVRS database).

With reference now to FIG. 9, shown is a flow diagram exhibiting another system and method 150 for computer-based vehicle registration (e.g., via the Internet). As shown, system and method 150 enable, e.g., the state, city or county tax assessor to register vehicles through the Internet and is similar to system and method 130 shown in FIG. 8. Both utilize MVRS 140 and MIVS 10. The only difference is that a tax assessor 64 (e.g., county or city tax assessor 56) performs the motor vehicle annual registration for vehicle owner 62. MVRS 140 also accesses MIVS 10 for automatic insurance coverage verification. State 54 sends an annual motor vehicle renewal registration notice to the vehicle owner, block 131. The notice may include an access code as described above. The motor vehicle owner 62 provides his/her notice and DL to tax assessor personnel 64, block 151. Tax assessor 64 accesses MVRS 140 and enters the notice access code, initiating the web based registration process, and enters the motor vehicle owner 62 DL, block 153. For example, tax assessor 64 may connect to and access MVRS 140 using government user machine 16 or other device. Tax assessor 64 may use a computer system configured to automatically connect to MVRS 140 and provide DL to MVRS 140. MVRS 140 accesses MIVS 10 for insurance coverage verification, block 155. For example, upon receiving DL, MVRS 140 may automatically connect to MIVS server 12 and/or MIVS database 14, pass the DL to look-up motorist 62 MIVS record, and retrieve/receive insurance coverage information from MIVS server 12 and/or MIVS database 14. Once insurance coverage information is confirmed for the vehicle owner 62 and his/her vehicle, the vehicle registration may be renewed. MVRS 140 may issue a new registration sticker to tax assessor or directly to vehicle owner 62 (e.g., as described above with reference to FIG. 8), block 157. MVRS 140 may upload an updated registration record for vehicle owner 62 to the state vehicle registration record system, block 159. Alternatively, MVRS 140 may maintain all state vehicle registration records and may simple save the updated vehicle registration record (e.g., on MVRS server and/or MVRS database).

With reference now to FIG. 10, shown is a flow diagram exhibiting another system and method 160 for computer-based vehicle registration (e.g., via the Internet). As shown, system and method 160 enable car dealerships 66 to register the vehicle for its new owner 62 and verify the driver's insurance coverage. By permitting dealership agent 66 to access MVRS 140, the registration process is shortened and insurance confirmation is done before the driver begins driving. Motorist 62 purchasing a car provides the driver's license to the dealership agent/sales person 66, block 161. Dealership agent/sales person 66 accesses MVRS 140 and enters the DL, initiating the web based registration process, block 163. For example, dealership agent/sales person 66 may connect to and access MVRS 140 using a user machine or other device. Dealership 66 may use a computer system configured to automatically connect to MVRS 140 and provide DL to MVRS 140. MVRS 140 accesses MIVS 10 for insurance coverage verification, block 165. For example, upon receiving DL, MVRS 140 may automatically connect to MIVS server 12 and/or MIVS database 14, pass the DL to look-up motorist 62 MIVS record, and retrieve/receive insurance coverage information from MIVS server 12 and/or MIVS database 14. Once MVRS 140 has verified insurance coverage, MVRS 140 may issue ownership a new registration sticker for new vehicle owner (e.g., as described above with reference to FIG. 8), block 167. MVRS 140 may upload an updated registration record for vehicle owner 62 to the state vehicle registration record system, block 169. Alternatively, MVRS 140 may maintain all state vehicle registration records and may simple save the updated vehicle registration record (e.g., on MVRS server and/or MVRS database).

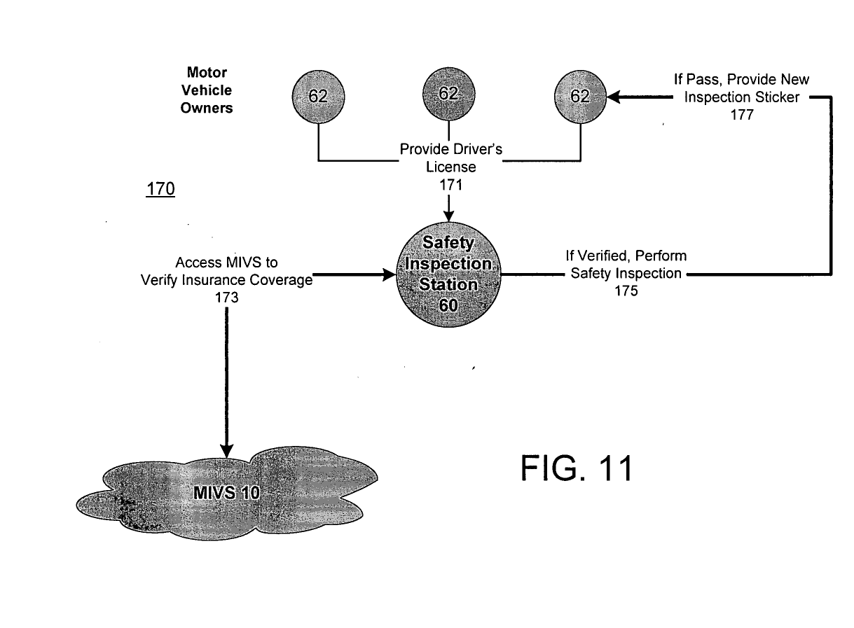

With reference to FIG. 11, shown is a flow diagram illustrating system and method 170 of insurance coverage verification utilized by safety inspection facilities 60 during annual motor vehicle inspections. Some states only inspect for motor vehicle emissions while others inspect for safety concerns such as brakes, lights, etc. Motorist/vehicle owner 62 provides his/her driver's license to a safety inspection agent 60, block 171. Safety inspection agent 60 accesses MIVS 10 to verify insurance coverage, block 173. For example, safety inspection agent 60 may use a user machine (e.g., government user machine 16) to connect (e.g., automatically) to MIVS server 12 and/or MIVS database 14, pass the DL to look-up motorist 62 MIVS record, and retrieve/receive insurance coverage information from MIVS server 12 and/or MIVS database 14. If insurance coverage is verified, safety inspection agent 60 performs the vehicle inspection (e.g., manual inspection and computerized inspection process), block 175. If the inspection is passed, a new inspection sticker is provided, block 177. For example, an inspection facility 60 computer system may print the new inspection sticker and the safety inspection agent 60 places it on the vehicle windshield.

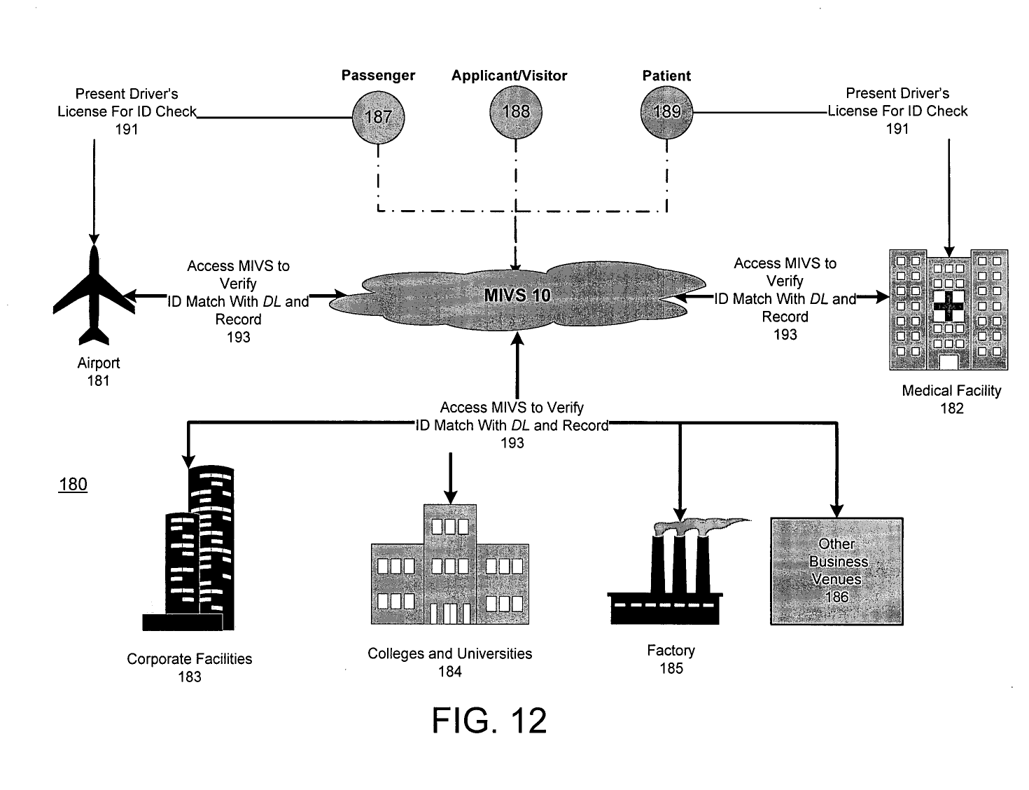

With reference now to FIG. 12, shown is a diagram illustrating a different usage of MIVS 10. Specifically, shown is system and method 180 of ID authentication. As described above, a crucial component of embodiments of insurance verification processes described herein is the driver's license, and more particularly, the DL. As noted above, a state agency 54 (e.g., DPS or DMV) may provide driver's license information to MIVS 10. This information can be manifested into an ID authentication procedure. With increasing cases of identity theft and fraud, system and method 180 provide a web based ID authentication may help combat identify theft and fraud. There are many industries that will benefit from system and method 180, among them are airports 181, medical facilities 182, corporate facilities 183, educational organizations (e.g., colleges and universities) 184, factories 185, and many other businesses 186. In use, a passenger 187, applicant/visitor 188, patient 189 or other person who's ID must be confirmed, presents their driver's license to the ID checking entity (airports 181, medical facilities 182, corporate facilities 183, educational organizations 184, factories 185, etc.), block 191.

The ID checking entity accesses MIVS 10 and verifies that the person identified on the driver's license matches the DL and the associated motorist record, block 193. For example, the ID checking entity may use a user machine or other device (e.g., hand-held computer) to connect (e.g., automatically) to MIVS 10 (e.g., DPS mirror DB), pass the DL to look up motorist 62 record, and retrieve motorist data associated with the record. The retrieved motorist data in the DL-indexed record includes data that identifies a person. If the person identified on the driver's license does not match the person identified by the DL-indexed record or if no record is located, the driver's license is fake and/or not valid for ID purposes. This assumes that the driver's license is from a jurisdiction participating in MIVS 10 and that the motorist record is up to date (e.g., if the motorist lost the driver's license, the loss was reported and the old driver's license expunged from MIVS 10 (or indicated as having been stolen/lost)). Information retrieved from MIVS 10 may also describe the motorist (height, weight, appearance, a photo, other personal information, etc.), enabling the ID checking entity to further confirm the person presenting the driver's license did not steal and/or alter the driver's license.

With reference now to FIG. 13, shown is system 200 for verifying insurance coverage. System 200 also may be used for online vehicle registration and ID authentication methods described herein. In the embodiment shown is an exemplary configuration of databases that support and enable the functionality of system 200. The databases include databases maintained by or for government entities for a jurisdiction participating in an implementation of MIVS 10 (state databases 202), databases maintained by or for insurance companies participating in an implementation of MIVS 10 (insurance co. databases 204), mirror databases 206 maintained as part of MIVS 10, MVRS database 208 and MIVS database 210 (i.e., MIVS database 14 described above). In addition to illustrating the databases, FIG. 13 also illustrates the flow of data between the various databases and to and from MIVS 10, as well as to and from external devices (e.g., user machines) such as workstations 212, PDAs 214, squad or police vehicle computers 216, etc., via, e.g., satellite 218, radio 220, and other wireless and wired mechanisms.

In the embodiment of system 200 shown, collaboration between the state and the insurance companies is vital for an effective and consistent insurance verification process. While the insurance company's provides all motorist and vehicle insurance information, the state contributes information from various state entities, including, e.g., the DPS, DMV and DI. The embodiment shown in FIG. 13 relies on the following assumptions (these assumptions may vary from state-to-state or jurisdiction-to-jurisdiction):

a) A single state entity is responsible for issuing driver's licenses. In many states, the DPS is the only entity that is authorized to issue driver's license. For example, the DL and other motorist information from drivers' licenses may be obtained by MIVS 10 (e.g., downloaded) from a DPS database 202. In other states or jurisdictions, the DMV or other similar entity is the entity authorized for issuing driver's licenses. By maintaining control of driver's license issuance in one entity, assurance is provided that the DL is accurate and reliable. The accuracy and reliability of the DL is an important feature for embodiments described herein. In these embodiments, DL is the main data field for verifying insurance coverage. The DL is mutually agreed upon by all the entities involved in the implementation. Note, the embodiments may be implemented with jurisdictions that permit multiple entities to issue driver's license, although reliability may be less assured;
b) A single state entity is responsible for vehicle registrations and ownership. In many states, the DMV is the sole authority that controls vehicle registration and vehicle ownership. For example, vehicle identification numbers (VINs), plate numbers, and other vehicle information are obtained (e.g., downloaded) by MIVS 10 from the DMV database 202. In other states or jurisdictions, other state entities may control vehicle registration and vehicle ownership. If one state entity, e.g., DMV, controls issuance of drivers' licenses and vehicle registration, then system 200 may include one DMV database 202 rather than a DPS and DMV database 202. Note, the embodiments may be implemented with jurisdictions that permit multiple entities to control vehicle registrations, although reliability may be less assured;
c) A single state entity is responsible for authorizing insurance companies to operate in the state and for maintaining information regarding the insurance companies. For example, a DI database 202 is the source that provides the information on the insurance companies that are licensed by the state to sell motorist and vehicle insurance coverage. The DI database may also maintain and supply data regarding self-insured vehicle owners in those jurisdictions that permit self-insurance. Note, the embodiments may be implemented with jurisdictions that permit multiple entities to authorizing insurance companies and maintaining insurance information; and,
d) The insurance companies are the source for motorist and vehicle insurance information. Insurance companies may maintain this information in an insurance company database 204.

In the embodiment shown in FIG. 13, the dependability of MIVS 10 depends in part on the integrity of state and insurance information. Accordingly, the state (e.g., DPS, DMV, DI) databases 202 and insurance databases 204 are of great importance. Implementations of MIVS 10 may utilize various known information assurance methods to protect these databases from corruption and other information related risks. One basic information assurance method is mirror databases. In the embodiment shown, MIVS 10 includes mirror databases 206 for each of the state databases 202, as well as for the insurance company database 204. Consequently, there are DPS, DMV and DI mirror databases 206 and an insurance company mirror database 206 maintained in MIVS 10.

In the embodiment shown, data transmission from state databases 202 and insurance companies' databases 204 to MIVS 10 may occur daily or more frequently. In the embodiment shown, this data transmission, however, occurs to update the mirror databases 206. In operation, MIVS 10 data retrieval activities are restricted to mirror databases 206 within the MIVS 10 network. Due to information assurance concerns, the state databases 202 and insurance company databases 204 are regarded as master data sources. Consequently, the state databases 202 and insurance company databases 204 involvement in MIVS 10 operations is minimized. As such, it is important to establish and implement communication guidelines between the state-insurance and MIVS 10 networks.

To reduce the operation costs of state and insurance networks in the embodiment shown, neither states nor insurance companies are required to alter their data structure to fit a MIVS 10 data configuration. After receiving or downloading data from state databases 202 and insurance databases 204, block 222 and block 224, to MIVS 10 data files in mirror databases 206, MIVS 10 extracts necessary data for insurance coverage verification methods described herein and stores the data in motorist records in MIVS database 210, block 226. MIVS 10 may download data from state databases 202 and insurance databases 204 on a regular, periodic basis. Alternatively, data may be “pushed” or uploaded to MIVS 10 whenever a change occurs (e.g., a new driver's license is issued, insurance coverage is issued, insurance coverage is changed, insurance coverage is cancelled, etc.) as described herein. MIVS 10 receives request for insurance coverage verification and performs matching between provided DL and motorist records in MIVS database 210 to find a match between DL, driver, vehicle, insurance information, etc. and return the results, via, e.g., various network or wireless devices, block 228. Such user machine receiving insurance coverage verification results include, e.g., workstations 212, PDAs 214, squad or police vehicle computers 216. Such results may be transmitted via satellite 218, radio 220 or other wireless or wired means.

Concurrently, the usage of the DL in the verification process enables automation in the vehicle registration procedure, as described above. Implementing MVRS 140 saves states additional operation costs. MVRS 140 includes data storage (MVRS database 208), a web-based vehicle registration application, and communication with MIVS 10, particularly MIVS database 210, for insurance coverage confirmation. MVRS 140 may be maintained as part of MIVS 10 or separately. MVRS 140 allows individual vehicle owners, car dealerships, county tax assessor, and other state licensed businesses to register vehicles. MVRS 140 receives requests for vehicle registration, block 230, and requests and receives insurance coverage verification from MIVS 10 (e.g., by communicating with MIVS database 210 and submitting DL for insurance coverage verification), block 232. MVRS database 208 may periodically update state DMV database 202 with new or updated vehicle registration records, block 234. This may be done, e.g., at midnight or other convenient time.

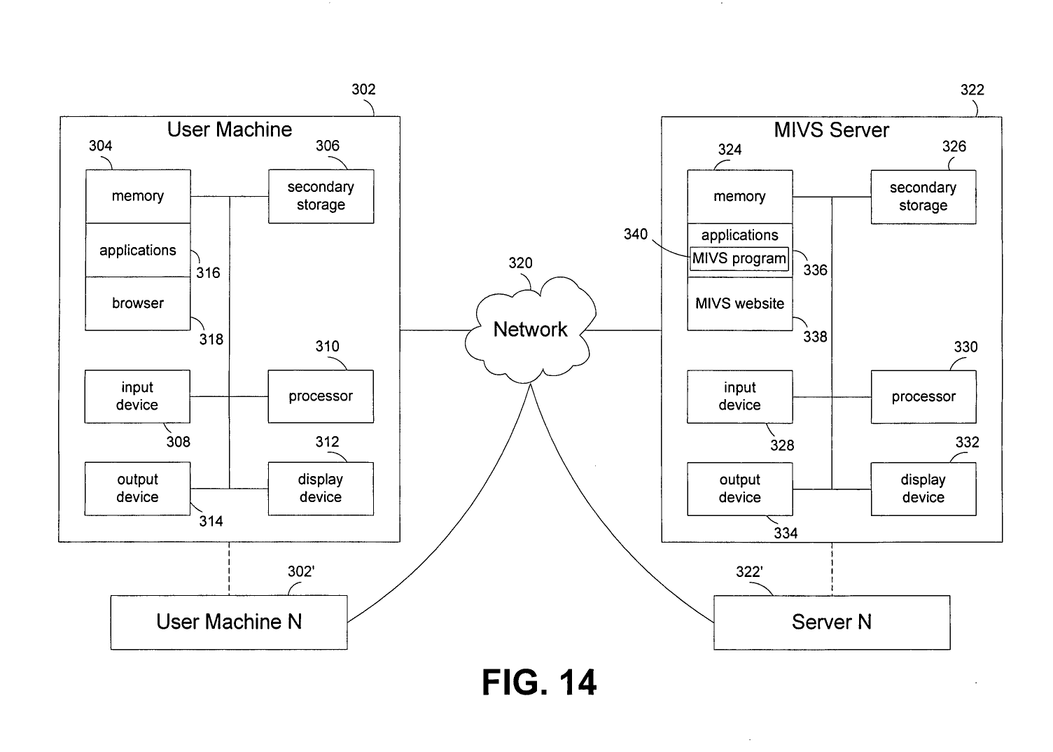

With reference now to FIG. 14, shown is a block diagram illustrating exemplary hardware components for implementing MIVS 10 and methods for verifying insurance coverage described herein. As discussed above, user machines, such as user machine 302, may be used to interact with MIVS 10 (and MVRS 140) and servers 322, such as MIVS server 12, providing functionality and data storage for MIVS 10. Users at user machines 302 may interact with server 322 to submit a request to verify insurance coverage, to upload insurance coverage information to MIVS database 14, to register a vehicle online through MVRS 140, etc. Server 322 may provide and maintain a web site, such as MIVS website 338, for providing a network connection to the application(s) 336 through which users can perform these steps. Users may also access one or more web site servers (not shown) in order to obtain content from the World Wide Web, if desired. Only two user machines are shown for illustrative purposes only; implementations may include many user machines and may be scalable to add or delete user machines to or from the network.

User machine 302 illustrates typical components of a user machine. User machine 302 typically includes a memory 304, a secondary storage device 306, a processor 310, an input device 308, a display device 312, and an output device 314. Memory 304 may include random access memory (RAM) or similar types of memory, and it may store one or more applications 316, and a web browser 318, for execution by processor 310. Secondary storage device 306 may include a hard disk drive, floppy disk drive, CD-ROM drive, or other types of non-volatile data storage. Processor 310 may execute applications 316 stored in memory 304 or secondary storage 306, or received from the Internet or other network 320, and the processing may be implemented in software, such as software modules, for execution by computers or other machines. These applications 316 preferably include instructions executable to perform portions of the methods described herein. The applications preferably provide graphical user interfaces (GUIs) through which users may enter information and perform method steps described herein. Input device 308 may include any device for entering information into machine 302, such as a keyboard, mouse, cursor-control device, touch-screen, microphone, digital camera, video recorder or camcorder. The input device 308 may be used to enter information into GUIs during performance of methods described herein. Display device 312 may include any type of device for presenting visual information such as, for example, a computer monitor or flat-screen display. The display device 312 may display the GUIs described above. Output device 314 may include any type of device for presenting a hard copy of information, such as a printer, and other types of output devices include speakers or any device for providing information in audio form.

Web browser 318 is used to access the application(s) 336 hosted by server 322, e.g., through web site 338 and display various web pages and GUIs through which the user can request insurance coverage verification, enter necessary data (e.g., DL), etc., as described above. Examples of web browsers include the Netscape Navigator program and the Microsoft Internet Explorer program. Any web browser, co-browser, or other application capable of retrieving content from a network and displaying pages or screens may be used.

Examples of user machines 302 include personal computers, laptop computers, notebook computers, palm top computers, network computers, handheld devices, cell-phones, PDAs, or any processor-controlled device capable of executing a web browser or other type of application for interacting with MIVS 10.

With continuing reference to FIG. 14, server 322 typically includes a memory 324, a secondary storage device 326, a processor 330, an input device 328, a display device 332, and an output device 334. Memory 324 may include RAM or similar types of memory, and it may store one or more applications 336, such as a MIVS program 340, for execution by processor 330. Secondary storage device 326 may include a hard disk drive, floppy disk drive, CD-ROM drive, or other types of non-volatile data storage. Processor 330 executes the application(s) 336, which is stored in memory 324 or secondary storage 326, or received from the Internet or other network 320. Input device 328 may include any device for entering information into server 322, such as a keyboard, mouse, cursor-control device, touch-screen, microphone, digital camera, video recorder or camcorder. Display device 332 may include any type of device for presenting visual information such as, for example, a computer monitor or flat-screen display. Output device 334 may include any type of device for presenting a hard copy of information, such as a printer, and other types of output devices include speakers or any device for providing information in audio form.

Server 322 may store a database structure (e.g., MIVS database 14) in secondary storage 326, for example, for storing and maintaining information for verifying insurance coverage. For example, it may maintain a relational or object-oriented database for storing information concerning motorists (e.g., motorist records, with DL, insurance coverage information, biographical information, etc.) or vehicles. Using the database structure, the application 336 may search for a motorist record by seeking a DL-match, retrieve requested insurance coverage information, store motorist information, etc.

Also, processor 330 may execute one or more software applications 336, such as MIVS program 340, in order to provide the functions described in this specification, specifically in the methods described herein, and the processing may be implemented in software, such as software modules, for execution by computers or other machines. The processing may provide and support web pages and other GUIs described in this specification and otherwise for display on display devices associated with the user machines 302. The term “screen” refers to any visual element or combinations of visual elements for displaying information or forms; examples include, but are not limited to, GUIs on a display device or information displayed in web pages or in windows on a display device. The GUIs may be formatted, for example, as web pages in Hypertext Markup Language (HTML), Extensible Markup Language (XML) or in any other suitable form for presentation on a display device depending upon applications used by users to interact with MIVS 10.

The GUIs preferably include various sections, to provide information or to receive information or commands. The term “section” with respect to GUIs refers to a particular portion of a GUI, possibly including the entire GUI. Sections are selected, for example, to enter information or commands or to retrieve information or access other GUIs. The selection may occur, for example, by using a cursor-control device to “click on” or “double click on” the section; alternatively, sections may be selected by entering a series of key strokes or in other ways such as through voice commands or use of a touch screen or similar 6 functions of displaying information and receiving information or commands.

Although only one server 322 is shown, the systems described herein, include MIVS 10 and MVRS 140, may use multiple servers as necessary or desired to support the users and may also use back-up or redundant servers to prevent network downtime in the event of a failure of a particular server. In addition, although user machine 302 and server 322 are depicted with various components, one skilled in the art will appreciate that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as user machine 302 and server 322, to perform a particular method or methods.

The problem of UIM is a matter that requires tenacious approach by the state, insurance companies, law enforcement authorities, and the general motorists' body. It is an encounter that needs continual attention. Described and shown herein are illustrative implementations of a system and method for a coherent and reliable execution of insurance coverage verification tasks. The integration of the process may affect the police, vehicle annual registration and inspection procedures, as well as the production of driver's licenses or purchasing a car.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A computerized system for insurance coverage verification, comprising:
an insurance coverage verification server, that receives and processes requests for insurance coverage verification, wherein each request for insurance coverage verification includes a driver's license number (“DL”) identifying a motorist for which insurance coverage verification is sought;
a insurance coverage verification database that stores insurance coverage information in a plurality of motorist records that are indexed by DLs, wherein the insurance coverage verification server verifies that the motorist has insurance coverage by matching the DL included in a request to an indexing DL in the database and retrieving the DL-indexed motorist record, wherein the DL-indexed record is the motorist's only proof of insurance; and
a network connection for receiving the insurance coverage verification requests and communicating responses to the insurance coverage verification.

2. The system of claim 1 further comprising a plurality of user machines for accessing the insurance coverage verification server and the insurance coverage verification database through the network connection to request insurance coverage verification.

3. The system of claim 2 wherein the user machines include government user machines.

4. The system of claim 3 wherein the government user machines include police squad car computers.

5. The system of claim 3 wherein the government user machines include state inspection facility computers.

6. The system of claim 3 wherein the government user machines include department of motor vehicle computers.

7. The system of claim 3 wherein the government user machines include department of public safety computers.

8. The system of claim 2 wherein the user machines include insurance company user machines.

9. The system of claim 2 wherein the user machines include motorist user machines.

10. The system of claim 1 further comprising a network connected to the network connection over which insurance coverage verification requests and responses are sent and received.

11. The system of claim 10 wherein the network is the Internet.

12. The system of claim 10 wherein the network is wireless.

13. The system of claim 1 further comprising a motor vehicle registration server that receives and processes requests to register a motor vehicle.

14. The system of claim 13 wherein the motor vehicle registration server connects to the insurance coverage verification server to request insurance coverage verification for a motorist seeking motor vehicle registration.

15. The system of claim 14 wherein the motor vehicle registration server issues a vehicle registration upon receiving verification of insurance coverage.

16. The system of claim 1 wherein the insurance coverage verification database stores motorist records with insurance coverage information for motorists from a plurality of jurisdictions.

17. The system of claim 16 wherein the plurality of jurisdictions include a plurality of states.

18. The system of claim 1 wherein the insurance coverage verification database stores motorist records with insurance coverage information for motorists insured by a plurality of insurance companies.

19. The system of claim 1 wherein the insurance coverage verification database is configured to store motorist records for motorists that have insurance coverage and motorists that do not have insurance coverage.

20. The system of claim 1 wherein the insurance coverage verification database is configured to store motorist records only for motorists that have insurance coverage.

21. The system of claim 1 wherein the insurance coverage verification server also receives and processes identification authentication requests that include a DL of a individual for which authentication is requested, wherein the insurance coverage verification server looks up a motorist record in a database using the individual's DL, so that data in the motorist record may be used to authenticate the individual's identification.

22. The system of claim 21 wherein the insurance coverage verification server looks up the motorist record in a department of insurance mirror database.

23. The system of claim 1 further comprising a plurality of mirror databases, wherein the mirror databases mirror state and insurance company databases that are maintained by states and insurance companies.

24. A computer-assisted method for insurance coverage verification, comprising:
receiving a driver's license registration, wherein the driver's license registration indicates the issuance or existence of a driver's license for a motorist and includes a driver's license number (DL);
creating a motorist record for the motorist in an insurance verification database, wherein the motorist record is indexed by the DL;
receiving an insurance coverage registration, wherein the insurance coverage registration indicates issuance of insurance coverage for the motorist and includes the motorist's DL and insurance coverage information;
looking up the motorist record using the motorist's DL; and
storing the insurance coverage information with the motorist record located using the motorist's DL, wherein the motorist record and the insurance coverage information stored therewith is the motorist's sole proof of insurance.

25. The computer-assisted method of claim 24 further comprising receiving a request for insurance coverage verification of a motorist, wherein the request includes only a DL.

26. The computer-assisted method of claim 25 further comprising verifying insurance coverage of the motorist using the DL.

27. The computer-assisted method of claim 26 wherein verifying insurance coverage of the motorist includes:
matching the DL in the request to a DL in the insurance coverage verification database; and
retrieving insurance coverage information in the motorist record indexed by the matched DL.

28. The computer-assisted method of claim 24 further comprising updating insurance coverage information stored in the motorist record, wherein the updating includes:
receiving an update request with a DL;
matching the DL in the update request to a DL in the insurance coverage verification database; and
updating the insurance coverage information in the motorist record indexed by the matched DL.

29. The computer-assisted method of claim 24 further comprising issuing a driver's license to the motorist.

30. The computer-assisted method of claim 24 further comprising issuing insurance coverage to the motorist.

31. The computer-assisted method of claim 24 wherein an insurance company provides the received insurance coverage registration and the DL.

32. A computer-assisted method of verifying insurance coverage, comprising:
receiving a driver's license number (DL) of a motorist;
connecting to an insurance coverage verification system;
requesting insurance coverage verification using only the DL, wherein the DL is provided to the insurance coverage verification system to confirm insurance coverage; and
receiving insurance coverage verification if the DL matches a DL in the insurance coverage verification system of a motorist with insurance coverage.

33. The computer-assisted method of claim 32, wherein the DL is received from a motorist seeking a driver's license renewal, the method further comprising issuing a driver's license renewal upon receiving insurance coverage verification.

34. The computer-assisted method of claim 32, wherein the DL is received from a motorist pulled over by a law enforcement officer for a moving violation, the method further comprising issuing a citation to the motorist.

35. The computer-assisted method of claim 32, wherein the DL is received from a motorist seeking a vehicle registration, the method further comprising issuing the vehicle registration upon receiving insurance coverage verification.

36. The computer-assisted method of claim 32, wherein the DL is received from a motorist seeking a vehicle safety inspection, the method further comprising issuing an inspection sticker upon receiving insurance coverage verification and passing safety inspection.

37. A computer-readable medium comprising instructions for insurance coverage verification, by:
receiving a driver's license registration, wherein the driver's license registration indicates the issuance or existence of a driver's license for a motorist and includes a driver's license number (DL);
creating a motorist record for the motorist in an insurance verification database, wherein the motorist record is indexed by the DL;
receiving an insurance coverage registration, wherein the insurance coverage registration indicates issuance of insurance coverage for the motorist and includes the motorist's DL and insurance coverage information;
looking up the motorist record using the motorist's DL; and
storing the insurance coverage information with the motorist record located using the motorist's DL, wherein the motorist record and the insurance coverage information stored therewith is the motorist's sole proof of insurance.

38. The computer-readable medium of claim 37 further comprising instructions for processing a request for insurance coverage verification of a motorist, wherein the request includes only a DL.

38. The computer-readable medium of claim 38 further comprising instructions for verifying insurance coverage of the motorist using the DL.

40. The computer-readable medium of claim 39 wherein verifying insurance coverage of the motorist includes:
matching the DL in the request to a DL in the insurance coverage verification database; and
retrieving insurance coverage information in the motorist record indexed by the matched DL.

41. The computer-readable medium of claim 37 further comprising instructions for updating insurance coverage information stored in the motorist record, wherein the updating includes:
receiving an update request with a DL;
matching the DL in the update request to a DL in the insurance coverage verification database; and
updating the insurance coverage information in the motorist record indexed by the matched DL.

42. A computer-readable medium comprising instructions for insurance coverage verification, by:
receiving a driver's license number (DL) of a motorist;
connecting to a insurance coverage verification system;
requesting insurance coverage verification using only the DL, wherein the DL is provided to the insurance coverage verification system to confirm insurance coverage; and
receiving insurance coverage verification if the DL matches a DL in the insurance coverage verification system of a motorist with insurance coverage.
